(19) United States
(12) Patent Application Publication
(10) Pub. No.: US 2016/0147197 A1
(43) Pub. Date: May 26, 2016

(54) FLEXIBLE COLLET

(71) Applicant: Nivarox-FAR S.A., Le Locle (CH)

(72) Inventor: Marc STRANCZL, Nyon (CH)

(73) Assignee: Nivarox-FAR S.A., Le Locle (CH)

(21) Appl. No.: 14/944,790

(22) Filed: Nov. 18, 2015

(30) Foreign Application Priority Data
Nov. 20, 2014 (EP) 14194118.7

(51) Int. Cl. G04B 17/34

(52) U.S. Cl. CPC G04B 17/34

(57) ABSTRACT

Timepiece collet comprising a point of attachment to a balance spring and a passage intended to receive a balance staff. According to the invention, the passage is substantially cylindrical and is configured to deform elastically in a plane perpendicular to the axis of the passage and to elastically clamp the balance staff by at least two lines of contact extending over the height of the inner wall of the passage when the balance staff is inserted in the passage.

### FIELD OF THE INVENTION

The invention relates to a resilient collet intended to be fixed on an arbor. The invention also concerns a one-piece balance spring/resilient collet assembly, and a method for manufacturing such a one-piece assembly.

This application claims priority from European Patent Application No. 1419118.7 filed Nov. 20, 2014, the entire disclosure of which is hereby incorporated herein by reference.

### BACKGROUND OF THE INVENTION

Generally, the balance spring is placed on the balance staff by means of a collet, which takes the form of a ring intended to be pressed onto the balance staff and pierced laterally to receive the inner end of the balance spring. The balance staff may also be welded or soldered on the collet. The development of micro-manufacturing techniques, such as DRIE methods for silicon, have made it possible to manufacture collets with new shapes and geometries. It is possible, in particular, to make the collet in one-piece with the balance spring.

Silicon is a material exhibiting numerous advantages for the manufacture of balance springs, and micro-manufacturing techniques make it possible to form a one-piece balance spring/collet assembly. The main drawback of silicon is that it has no plastic deformation. Collets can thus break easily if stresses exceed the elastic limit. The collet must therefore be dimensioned both to hold the balance spring on the balance staff during operation of the oscillator (minimum clamping torque), and to allow the collet to be assembled to arbors without breaking (or undergoing plastic deformation) if the diameter of the balance staff and the geometric variations of the collet remain within a given tolerance range.

EP Patent No 1513029 and EP Patent No 2003523 propose collets having a triangular opening. The balance spring is fixed at a point of attachment located at one of the apexes of the triangles. The collet is formed of an external stiffening structure to which there are attached flexible arms which deform to accommodate the balance staff.

There is also known from WO Patent No 2011026725 a balance spring-collet assembly, with a collet having a bore provided with four circular support portions for receiving the balance staff. The support portions are delimited by longitudinal grooves made in the collet bore.

The geometries described in these documents are not entirely satisfactory, so that many of balance springs (made of silicon, diamond, quartz . . . ) mounted on movements are provided with a collet adhesive bonded on the balance staff.

### SUMMARY OF THE INVENTION

It is an object of the present invention to overcome all or part of the aforementioned drawbacks.

To this end, the invention relates to a timepiece collet comprising a point of attachment to a balance spring and a passage or opening intended to receive a balance staff.

According to the invention, the passage is substantially cylindrical and is configured to deform elastically in a plane perpendicular to the axis of the passage and to elastically clamp the balance staff by at least two lines of contact extending over the height of the inner wall of the passage when the balance staff is inserted in the passage.

It is thus understood that such a collet allows for optimum pressing-in force and holding torque, with the deformation force clamping the collet onto the staff above a nominal holding torque.

One advantage of the invention is that the entire collet is deformed, unlike prior art collets, the collet has no nose or other rigid portion. In the case of the invention, virtually the entire collet is deformed, except for the point of attachment of the collet.

In accordance with other advantageous variants of the invention:
the passage is ovoid-shaped;
the three lines of contact have angular openings α, β, θ, one of the lines of contact being diametrically opposite the point of attachment to the balance spring;
the angular openings α, β, θ are greater than 90°;
the angular openings α, β, θ are equal to 120′;
the distance between the balance staff and the collet at the recessed parts is comprised between 0 and one quarter of the diameter of the balance staff, and more preferably between 0 and 50 μm,
the collet is of variable section.

The invention also concerns a one-piece collet/balance spring assembly comprising a collet according to the invention.

In accordance with other advantageous variants of the invention:
the collet and the balance spring are made of silicon;
the collet and the balance spring are made of a material having no plastic deformation.

The invention also concerns a timepiece movement or a timepiece comprising a collet/balance spring assembly according to the invention.

### BRIEF DESCRIPTION OF THE DRAWINGS

Other features and advantages will appear clearly from the following description, given by way of non-limiting illustration, with reference to the annexed drawings, in which:

FIG. 1 is a diagram in which the collet is elastically deformed;

FIG. 2 is a top view diagram of a collet/balance spring assembly according to the invention.

### DETAILED DESCRIPTION OF PREFERRED EMBODIMENTS

As explained above, the invention relates to a collet made of a material with no usable plastic range, i.e. with a very limited plastic range.

The collet/balance spring assembly illustrated in FIG. 2 is made in a single one-piece component, typically made of silicon. It comprises a collet 1 and a balance spring 2 attached via the inner coil 20 thereof to a point of attachment S1 on the periphery of collet 1. The collet/balance spring assembly is held on a balance staff 4 of circular section by driving collet 1 onto staff 4.

Collet 1 includes a substantially cylindrical passage 10, configured to deform elastically in a plane P perpendicular to the axis of passage 10 and thus to receive and elastically clamp balance staff 4. Flexible passage 10 is ovoid in shape, and more preferably “triangular-oval”, and includes at least two lines of contact with balance staff 4.

According to a preferred embodiment illustrated in the Figures, flexible passage 10 is triangular-oval in shape, and has three lines of contact 11a, 11b and 11c with balance staff 4, the three lines of contact forming, for example, an equilateral triangle. The three lines of contact 11a, 11b, 11c with balance staff 4 form angles α, β and θ between them.

Lines of contact 11a, 11b and 11c delimit recessed parts 10a, 10b and 10c between collet 1 and balance staff 4, these recessed parts 10a, 10b and 10c being non-contact areas.

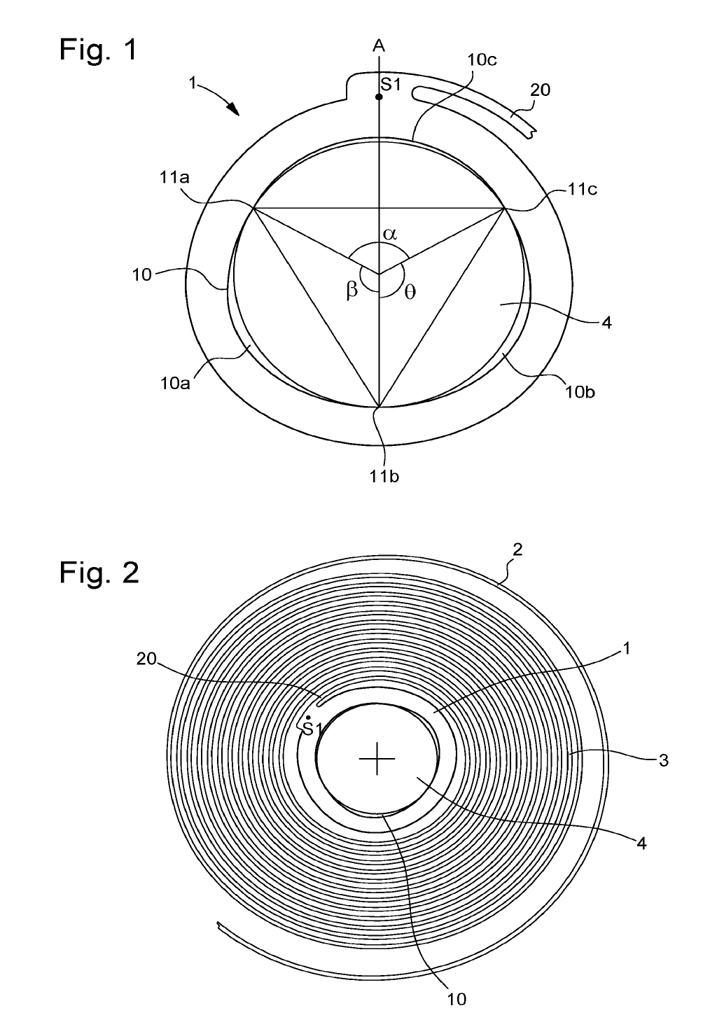

As can be observed in FIG. 1, one of the lines of contact is diametrically opposite the point of attachment to balance spring 2, and therefore collet 1 does not undergo deformation at the point of attachment and the position of the point of attachment of balance spring 2 is not altered when collet 1 is set in place.

According to the invention, the three lines of contact 11a, 11b and 11c form between them an angle which is preferably greater than 90°, more preferably less than 150°, and here is substantially equal to 120°.

Under the effect of elastic deformation, passage 10 exerts, at lines of contact 11a, 11b, 11c, elastic return forces returning the inner wall of the passage into contact with the balance staff.

According to the invention, the distance between balance staff 4 and collet 1 at recessed parts 10a, 10b and 10c is greater than 0. There is thus a clamping force at the three lines of contact 11a, 11b and 11c but no clamping force at recessed parts 10a, 10b and 10c.

Preferably, the distance between balance staff 4 and collet 1 at recessed parts 10a, 10b and 10c is comprised between 0 and a quarter of the diameter of balance staff 4. Even more preferably, the distance between balance staff 4 and collet 1 at recessed parts 10a, 10b and 10c is comprised between 0 and 50 μm.

Advantageously, the distance between balance staff 4 and collet 1 ensures a small amount of play when a clamping force is applied at contact lines 11 a, 11 B and 11 C.

This arrangement has the particular advantage of maximising the radius of support of passage 10 of collet 1 on staff 4, while ensuring sufficient holding torque on balance staff 4, with a lower level of stress than the maximum allowable stress of the material. Advantageously, a larger radius of support provides a higher holding torque.

Thickness is determined so that the maximum stress exerted by balance staff 4 on passage 10 is lower than the elastic limit of the material forming collet 1, so that collet 1 adapts to the manufacturing tolerances of balance staff 4 and so that the hold of collet 1 on staff 4 (rotational torque, pressing-in force) is adequate.

As illustrated in FIG. 2, balance spring 2 includes a strip 3 wound in coils around itself, the inner coil 20 being integral with collet 1.

As seen in FIG. 2, the point of attachment S1 between inner coil 20 and collet 1 is located on collet 1. It is also noted that collet 1 is symmetrical relative to the axis A passing through the centre C of collet 1 and the point of attachment S1.

According to a preferred embodiment of the invention, collet 1 and balance spring 2 are made of silicon.

According to another embodiment of the invention, collet 1 and balance spring 2 are formed of a material with no plastic deformation, such as single crystal silicon, polycrystalline silicon, porous silicon, amorphous silicon, doped single crystal silicon, doped polycrystalline silicon, doped or undoped silicon carbide, doped or undoped silicon nitride, doped or undoped silicon oxide such as quartz or silica, or ceramic.

Collet 1 and balance spring 2 may also be made of a material such as amorphous metal.

Of course, this invention is not limited to the illustrated example but is capable of various variants and alterations that will appear to those skilled in the art.

### LIST OF PARTS

1 Collet
10 Passage
10a Recessed part
10b Recessed part
10c Recessed part
11a Line of contact
11b Line of contact
11c Line of contact
2 Balance spring
3 Balance spring strip
4 Balance staff
α Angle
β Angle
θ Angle
S1 Point of attachment
C Centre of the collet
Da Staff diameter

What is claimed is:

1. A timepiece collet comprising a point of attachment with a balance spring and a passage intended to receive a balance staff,
wherein the passage is substantially cylindrical and is configured to deform elastically in a plane perpendicular to the axis of the passage and to elastically clamp the balance staff by at least two lines of contact extending over the height of the inner wall of the passage when the balance staff is inserted in the passage.

2. The timepiece collet according to claim 1, wherein the passage is ovoid in shape.

3. The collet according to claim 1, wherein the three lines of contact have angular openings α, β, θ, one of the lines of contact being diametrically opposite the point of attachment to the balance spring.

4. The collet according to claim 3, wherein the angular openings α, β, θ are greater than 90°.

5. The collet according to claim 3, wherein the angular openings α, β, θ are equal to 120°.

6. The collet according to claim 1, wherein the distance between the balance staff and the collet at the recessed parts is comprised between 0 and one quarter of the diameter of the balance staff, and more preferably between 0 and 50 μm.

7. The collet according to claim 1 comprising a variable section.

8. The one-piece collet/balance spring assembly comprising a collet according to claim 1.

9. The one-piece collet/balance spring assembly according to claim 8, wherein the collet and the balance spring are made of silicon.

10. The one-piece collet/balance spring assembly according to claim 8, wherein the collet and the balance spring are made of a material with no plastic deformation.

11. The timepiece movement or timepiece comprising a one-piece collet/balance spring assembly according to claim 8.
